(19) United States
(12) Patent Application Publication
(10) Pub. No.: US 2025/0157197 A1
(43) Pub. Date: May 15, 2025

(54) METHODS AND APPARATUSES FOR TRAINING CONTENT UNDERSTANDING MODEL AND CONTENT GENERATION MODEL

(71) Applicant: Alipay (Hangzhou) Information Technology Co., Ltd., Hangzhou (CN)

(72) Inventors: Ziping Ma, Hangzhou (CN); Qingpei Guo, Hangzhou (CN)

(73) Assignee: Alipay (Hangzhou) Information Technology Co., Ltd., Hangzhou (CN)

(21) Appl. No.: 18/940,207

(22) Filed: Nov. 7, 2024

(30) Foreign Application Priority Data
Nov. 13, 2023 (CN) 202311508270.9

(51) Int. Cl. G06V 10/774; G06V 10/72; G06V 10/74

(52) U.S. Cl. CPC G06V 10/774; G06V 10/72; G06V 10/761

(57) ABSTRACT

Separately training a content understanding model and a content generation model with an image-text pair formed by an image and a text in a target training set. Sample processing is performed on a noise-containing sample set, including: inputting a first image in any first image-text pair in the noise-containing sample set into the content understanding model to obtain several candidate texts; separately inputting a first text in the first image-text pair and the several candidate texts into the content generation model to obtain multiple candidate images; performing similarity matching between the multiple candidate images and the first image to determine a target text; and continuing to train the content understanding model and the content generation model by forming a second image-text pair by using the first image and the target text and adding the second image-text pair to the target training set.

### CROSS-REFERENCE TO RELATED APPLICATIONS

This application claims priority to Chinese Patent Application No. 202311508270.9, filed on Nov. 13, 2023, which is hereby incorporated by reference in its entirety.

### TECHNICAL FIELD

One or more embodiments of this specification relate to the field of machine learning, and in particular, to methods and apparatuses for training a content understanding model and a content generation model.

### BACKGROUND

In machine learning model training, both a content understanding model and a content generation model require a large quantity of high-quality images and texts to train data, where the content understanding model is used to generate an image description text based on an input image, the content generation model is used to generate a corresponding image based on an input description text, and data used to train the content understanding model and the content generation model can be privacy data collected in a case in which user authorization is obtained. However, existing large-scale image-text pair data sets are crawled from the Internet. These low-quality data sets include a large quantity of mismatched image-text content or noise data in multiple languages.

Training the content understanding model and the content generation model on the low-quality noise-containing data set forces the models to associate mismatched data, thereby significantly affecting model performance, while manually cleaning the low-quality data is expensive and time-consuming. Therefore, there is a need for a method for better training a content understanding model and a content generation model on a low-quality training set.

### SUMMARY

One or more embodiments of this specification describe methods and apparatuses for training a content understanding model and a content generation model. While a content understanding model and a content generation model are being trained, a low-quality training set is cleaned and re-labeled, so as to obtain a high-quality image-text pair data set and a content understanding model and a content generation model that are trained on the high-quality data set.

According to a first aspect, a method for training a content understanding model and a content generation model is provided, including: separately training a content understanding model and a content generation model by using an image-text pair formed by an image and a text in a target training set, where the content understanding model is used to generate an image description text based on an input image, and the content generation model is used to generate a corresponding image based on an input description text; and performing sample processing on a noise-containing sample set, where an image-text matching degree of an image-text pair in the noise-containing sample set is less than that in the target training set, and the sample processing includes: inputting a first image in any first image-text pair in the noise-containing sample set into the content understanding model to obtain several candidate texts; separately inputting a first text in the first image-text pair and the several candidate texts into the content generation model to obtain multiple candidate images; performing similarity matching between the multiple candidate images and the first image, and determining a target text based on a matching result; and forming a second image-text pair by using the first image and the target text and adding the second image-text pair to the target training set, to continue to train the content understanding model and the content generation model.

In a possible implementation, the method further includes: continuing to train the content understanding model and the content generation model by using the updated target training set; or continuing to train the content understanding model and the content generation model by using an image-text pair newly added to the target training set.

In a possible implementation, the method further includes: obtaining the target training set and the noise-containing sample set, and dividing the noise-containing sample set into a first subset to an Nth subset, where image-text matching degrees of image-text pairs in the first subset to the Nth subset decrease sequentially; and the performing sample processing on a noise-containing sample set includes: sequentially performing the sample processing on the first subset to the Nth subset.

In a possible implementation, the obtaining the target training set and the noise-containing sample set, and dividing the noise-containing sample set into a first subset to an Nth subset includes: obtaining a first training set, where the first training set includes several image-text pairs formed by images and texts; and sorting the several image-text pairs in the first training set in descending order of image-text matching degrees, dividing the first training set into N+1 subsets based on a sorting result, and using an initial subset as the target training set and the remaining N subsets as the first subset to the Nth subset sequentially.

In a possible implementation, the first training set includes a third image-text pair, the third image-text pair includes a third image and a third text, and an image-text matching degree of the third image-text pair is determined by using the following method: inputting the third image into an image encoder of a multi-modal model to obtain a third image representation, where the multi-modal model further includes a text encoder, and the image encoder and the text encoder are jointly pre-trained, so encoding results of the image encoder and the text encoder are located in a same representation space; inputting the third text into the text encoder to obtain a third text representation; and calculating a similarity between the third image representation and the third text representation, and determining the similarity as the image-text matching degree of the third image-text pair.

In a possible implementation, the multi-modal model is a CLIP model.

In a possible implementation, the performing similarity matching between the multiple candidate images and the first image includes: separately inputting the multiple candidate images and the first image into an image encoder to obtain multiple candidate image representations and a first image representation; and separately performing similarity matching between the multiple candidate image representations and the first image representation.

In a possible implementation, the image encoder is an image encoder of a CLIP model.

In a possible implementation, the determining a target text based on a matching result includes: determining a candidate image having a highest similarity with the first image as a first target image; and determining, as the target text, a text used when the first target image is generated.

In a possible implementation, the multiple candidate images include a seed candidate image generated based on the first text; and the determining a target text based on a matching result includes: sorting the multiple candidate images in descending order of similarities with the first image, and determining a ranking position of the seed candidate image in the sorting as a first ranking position; and if the first ranking position is less than or equal to a predetermined first threshold, determining the first text as the target text; if the first ranking position is greater than or equal to a predetermined second threshold, determining an image having a highest similarity as a second target image, and determining, as the target text, a text used when the second target image is generated; or if the first ranking position is greater than the first threshold and is less than the second threshold, sending the first text, the first image, and the several candidate texts to a manual labeling platform, and determining a text returned by the manual labeling platform as the target text.

According to a second aspect, an apparatus for training a content understanding model and a content generation model is provided, including: a first model training unit, configured to separately train a content understanding model and a content generation model by using an image-text pair formed by an image and a text in a target training set, where the content understanding model is used to generate an image description text based on an input image, and the content generation model is used to generate a corresponding image based on an input description text; and a sample processing unit, configured to: perform sample processing on a noise-containing sample set, where an image-text matching degree of an image-text pair in the noise-containing sample set is less than that in the target training set, and the sample processing includes: inputting a first image in any first image-text pair in the noise-containing sample set into the content understanding model to obtain several candidate texts; separately inputting a first text in the first image-text pair and the several candidate texts into the content generation model to obtain multiple candidate images; performing similarity matching between the multiple candidate images and the first image, and determining a target text based on a matching result; and forming a second image-text pair by using the first image and the target text and adding the second image-text pair to the target training set, to continue to train the content understanding model and the content generation model.

In a possible implementation, the apparatus further includes: a second model training unit, configured to continue to train the content understanding model and the content generation model by using the updated target training set; or configured to continue to train the content understanding model and the content generation model by using an image-text pair newly added to the target training set.

In a possible implementation, the apparatus further includes: a sample set division unit, configured to: obtain the target training set and the noise-containing sample set, and divide the noise-containing sample set into a first subset to an Nth subset, where image-text matching degrees of image-text pairs in the first subset to the Nth subset decrease sequentially; and the performing sample processing on a noise-containing sample set includes: sequentially performing the sample processing on the first subset to the Nth subset.

According to a third aspect, a computer-readable storage medium is provided. The computer-readable storage medium stores a computer program, and when the computer program is executed in a computer, the computer is enabled to perform the method of the first aspect.

According to a fourth aspect, a computing device is provided and includes a memory and a processor. Executable code is stored in the memory, and when executing the executable code, the processor implements the method of the first aspect.

According to the method and the apparatus for training a content understanding model and a content generation model proposed in the embodiments of this specification, while a content understanding model and a content generation model are being trained, a low-quality training set is cleaned and re-labeled, so as to obtain a high-quality image-text pair data set and a content understanding model and a content generation model that are trained on the high-quality data set.

### BRIEF DESCRIPTION OF DRAWINGS

To describe the technical solutions in multiple embodiments disclosed in this specification more clearly, the following briefly describes the accompanying drawings needed for describing the embodiments. Clearly, the accompanying drawings in the following description show merely multiple embodiments disclosed in this specification, and a person of ordinary skill in the art can still derive other drawings from these accompanying drawings without creative efforts.

FIG. 1 is a schematic diagram illustrating an implementation scenario of a method for training a content understanding model and a content generation model, according to an embodiment;

FIG. 2 is a schematic diagram illustrating an implementation scenario of a method for training a content understanding model and a content generation model, according to another embodiment;

FIG. 3 is a flowchart illustrating a method for training a content understanding model and a content generation model, according to an embodiment;

FIG. 4 is a schematic diagram illustrating a scenario in which data set cleaning and model training are performed alternately, according to an embodiment; and

FIG. 5 is a schematic block diagram illustrating an apparatus for training a content understanding model and a content generation model, according to an embodiment.

### DESCRIPTION OF EMBODIMENTS

The following describes the solutions provided in this specification with reference to the accompanying drawings.

As described above, training a content understanding model and a content generation model needs to use image-text pair data including image data and text data, where the text data are used to describe content included in a corresponding image. However, existing large-scale image-text pair data sets are crawled from the Internet. These low-quality data sets include a large quantity of mismatched image-text content or noise data in multiple languages. For example, content of an image in an image-text pair is a red car, but corresponding text content is “baby botanical emollient massage oil 80 ml*3 bottles”, which causes an image-text content mismatch. For another example, content of an image in another image-text pair is an unmanned aerial vehicle displayed on an aeronautical exhibition, but corresponding text content is “Arabica mellow coffee beans”. Not only image-text content does not match, but also content in the text is mixed in multiple languages, which is difficult to be directly used in a training model.

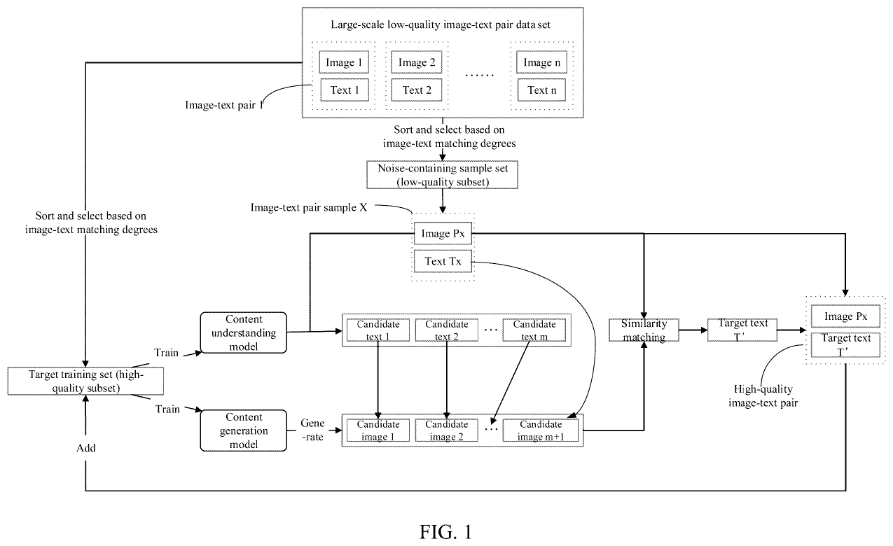

To alleviate the previous problem, FIG. 1 is a schematic diagram illustrating an implementation scenario of a method for training a content understanding model and a content generation model, according to an embodiment. In an example of FIG. 1, an initial large-scale low-quality image-text pair data set includes n image-text pairs, and texts in the image-text pairs are used to describe content in images. Image-text pairs in the initial data set are sorted in descending order of image-text matching degrees, and some image-text pairs with relatively high matching degrees are selected as a target training set (a high-quality subset), and remaining image-text pairs are used as a noise-containing data set (a low-quality subset) waiting for cleaning and re-labeling in subsequent steps. The image-text matching degree refers to a matching degree between a text description and image content. A higher matching degree indicates that a text can more accurately describe content in an image. A specific measurement method for the image-text matching degree is described later. Then, a content understanding model and a content generation model are separately trained by using a high-quality target training set.

Then, an image-text pair in a noise-containing sample set is re-labeled. For any image-text pair sample X in the noise-containing sample set, the image-text pair sample X includes an image Px and a text Tx. The image Px is input into the content understanding model, and m candidate texts used to describe the image are generated based on the image Px. Then, the m candidate texts and the text Tx are separately input into the content generation model, and corresponding m+1 candidate images are generated based on the inputted texts, where a candidate image numbered m+1 can be generated based on the text Tx. Then, similarity matching is separately performed on the m+1 candidate images and the image Px, a most appropriate text is determined from the m candidate texts and the text Tx as a target text T′ based on a matching result, a new high-quality image-text pair is formed by using the image Px and the target text T′, and the high-quality image-text pair is added to the target training set, so as to complete re-labeling of the image-text pair X.

Any image-text pair in the noise-containing data set is re-labeled and added to the target training set based on the previous method, that is, data in the noise-containing data set are cleaned to obtain a new target training set that includes multiple high-quality image-text pairs. Using the new target training set, the content understanding model and the content generation model can be further trained to obtain a high-quality content understanding model and content generation model.

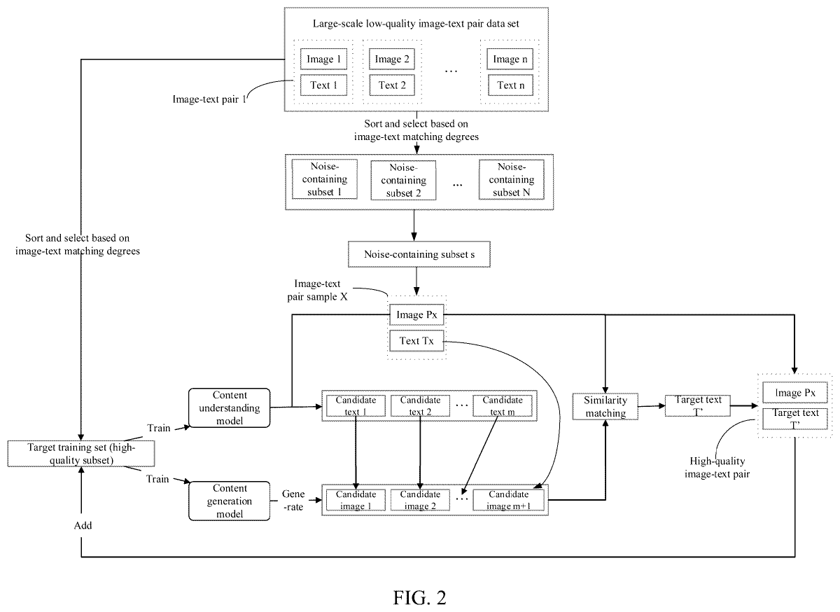

Further, in some embodiments, using the previous method may result in selecting less data in the target training set from the initial data set. In this case, the noise-containing sample set can be further divided into several noise-containing subsets based on image-text matching degrees. After cleaning of one or more noise-containing subsets is completed, the content understanding model and the content generation model are retrained by using the updated target training set, and then the trained content understanding model and content generation model are used to clean a noise-containing subset with a lower image-text matching degree, so as to implement cleaning and training alternately, so as to improve a cleaning effect on a subsequent noise-containing subset. FIG. 2 is a schematic diagram illustrating an implementation scenario of a method for training a content understanding model and a content generation model, according to another embodiment. In an example of FIG. 2, after image-text matching degrees of an initial large-scale low-quality image-text data set are sorted by using a method similar to that in FIG. 1, and a high-quality target training set is selected, remaining noise-containing sample sets are divided into N noise-containing subsets in descending order of image-text matching degrees, to obtain a noise-containing subset 1, a noise-containing subset 2, until a noise-containing subset N that are sequentially arranged as shown in FIG. 2. Then, cleaning is sequentially performed on the noise-containing subset 1 to the noise-containing subset N based on the cleaning method described in FIG. 1, where a noise-containing subset s is cleaned in an sth round. After one or more rounds of cleaning are completed, the updated target training set is used to train the content understanding model and the content generation model again, and then a next round of cleaning is performed until cleaning of all noise-containing subsets is completed. Finally, a new target training set including multiple high-quality image-text pairs and a high-quality content understanding model and content generation model are obtained.

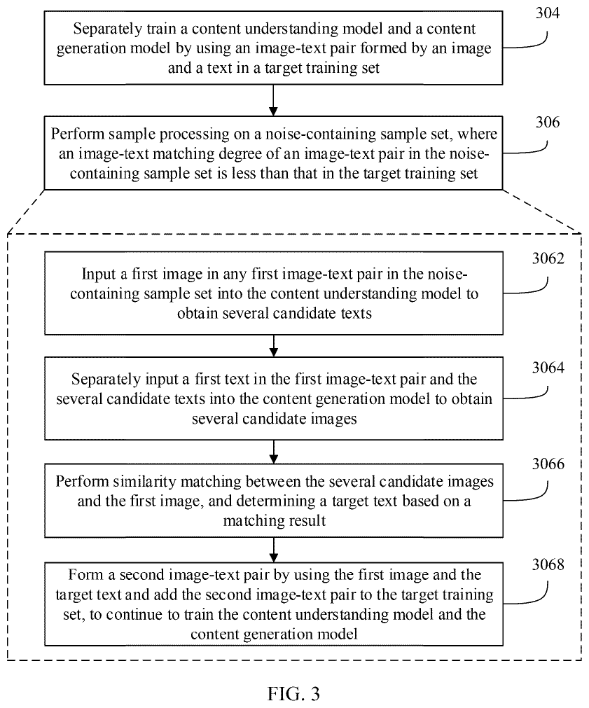

The following describes specific implementation steps of the previous method for training a content understanding model and a content generation model with reference to specific embodiments. FIG. 3 is a flowchart illustrating a method for training a content understanding model and a content generation model, according to an embodiment. The method is performed by any platform or server or device cluster having a computing and processing capabilities. As shown in FIG. 3, the method includes at least: step 304: separately train a content understanding model and a content generation model by using an image-text pair formed by an image and a text in a target training set, where the content understanding model is used to generate an image description text based on an input image, and the content generation model is used to generate a corresponding image based on an input description text; and; and step 306: perform sample processing on a noise-containing sample set, where an image-text matching degree of an image-text pair in the noise-containing sample set is less than that in the target training set, and the sample processing includes: step 3062: input a first image in any first image-text pair in the noise-containing sample set into the content understanding model to obtain several candidate texts; step 3064: separately input a first text in the first image-text pair and the several candidate texts into the content generation model to obtain multiple candidate images; step 3066: perform similarity matching between the multiple candidate images and the first image, and determine a target text based on a matching result; and step 3068: form a second image-text pair by using the first image and the target text and add the second image-text pair to the target training set, to continue to train the content understanding model and the content generation model. The following describes specific execution processes of the previous steps.

In step 304, the content understanding model and the content generation model are separately trained by using an image-text pair formed by an image and a text in a target training set, where the content understanding model is used to generate an image description text based on an input image, and the content generation model is used to generate a corresponding image based on an input description text.

Functions of the content understanding model and the content generation model can be implemented by using multiple models. For example, the content understanding model can use Bootstrapping Language-Image Pre-training (BLIP), ALign the image and text BEfore Fusing (ALBEF), One-For-All (OFA), and a Flamingo model, and the content generation model can use Stable Diffusion, ERNIE-ViLG, DALL-E, and an Imagen model, which are not limited here.

An image-text pair in the target training set has a relatively high matching degree, and is used to perform preliminary training on the content understanding model and the content generation model, so as to clean and re-label an image-text pair with a low matching degree in the noise-containing sample set in a subsequent step.

Then, in step 306, sample processing is performed on the noise-containing sample set, and the image-text matching degree of the image-text pair in the noise-containing sample set is lower than that in the target training set. Specifically, the sample processing in step 306 includes step 3062 to step 3068.

In step 3062, a first image in any first image-text pair in the noise-containing sample set is inputted into the content understanding model to obtain several candidate texts.

The first image can be corresponding to the image Px in FIG. 1. A quantity of candidate texts can be predetermined. For example, if the quantity is set to m, the first image is inputted into the content understanding model to obtain m candidate texts 1 to m that are used to express image content.

Specifically, the content understanding model generates the candidate text word by word (token by token). When a Kth word is generated in a Kth step, multiple candidate words of the Kth word and a probability that each candidate word is corresponding to a word sequence formed by the first K−1 words are generated based on the generated first K−1 words. When a candidate word is being selected, beam search is used, and a beam size is set to m, so the model reserves the first m word sequences with maximum current probabilities at each step of generation, and at the end of generation, the top ranked m candidate texts 1 to m with highest probabilities can be obtained.

In step 3064, the first text in the first image-text pair and the several candidate texts are separately inputted into the content generation model to obtain multiple candidate images.

The first text can correspond to the text Tx in FIG. 1. The first text Tx and the candidate text 1 to the candidate text m are separately inputted into the content generation model to obtain m+1 candidate images, that is, a candidate image 1 to a candidate image m+1, where the candidate image 1 to the candidate image m can correspond to the candidate text 1 to the candidate text m, and the candidate image m+1 can correspond to the first text Tx.

In step 3066, similarity matching is performed between the multiple candidate images and the first image, and the target text is determined based on the matching result.

In an embodiment, the performing similarity matching between the multiple candidate images and the first image can include: separately inputting the multiple candidate images and the first image into an image encoder to obtain multiple candidate image representations and a first image representation; and then separately performing similarity matching between the multiple candidate image representations and the first image representation.

Image encoding can be completed by using multiple image encoders, for example, an image encoder using a pre-trained contrastive language-image pre-training (CLIP) model, which is not limited here. After the candidate image 1 to the candidate image m+1 and the first image are separately encoded by using the image encoder to obtain a candidate image representation 1 to a candidate image representation m+1 and the first image representation, similarities between the candidate image representation 1 to the candidate image representation m+1 and the first image representation are separately calculated, for example, point product similarities or cosine similarities, and the target text is determined based on a similarity calculation result.

In another embodiment, a similarity between images can alternatively be calculated by using another method, for example, by calculating a mean square error between pixels corresponding to two images and using the mean square error as a similarity result, or by calculating a structural similarity index (SSIM) between two images as a similarity therebetween.

In an embodiment, the determining a target text based on a matching result can include: determining a candidate image having a highest similarity with the first image as a first target image, and determining, as the target text, a text used when the first target image is generated.

According to this embodiment, it is considered that a text in an image-text pair in an original data set is not reliable enough. Therefore, a text corresponding to a candidate image with a highest similarity ranking is directly determined as a target text.

In another embodiment, the multiple candidate images include a seed candidate image generated based on the first text. In this case, the determining a target text based on a matching result can include: sorting the multiple candidate images in descending order of similarities with the first image, and determining a ranking position of the seed candidate image in the sorting as a first ranking position; and if the first ranking position is less than or equal to a predetermined first threshold, determining the first text as the target text; if the first ranking position is greater than or equal to a predetermined second threshold, determining an image having a highest similarity as a second target image, and determining, as the target text, a text used when the second target image is generated; or if the first ranking position is greater than the first threshold and is less than the second threshold, sending the first text, the first image, and the several candidate texts to a manual labeling platform, and determining a text returned by the manual labeling platform as the target text.

Specifically, a candidate image Pₘ₊₁ numbered m+1 generated based on the first text is used as a seed candidate image, similarities between the m+1 candidate images and the first image Px are sorted in descending order, and a ranking position of the candidate image Pₘ₊₁ in the sorting is determined as a first ranking position r. Then, a first threshold A and a second threshold B are predetermined, where A<B. If r<=A, the first text is determined as the target text; or if r>=B, it is considered that the similarity is too low, and further, a text corresponding to an image with a highest similarity is determined as the target text. If A<r<B, that is, when the ranking of the seed candidate image is in an intermediate position, a most appropriate text is selected from the first text and the m candidate texts by using a manual labeling platform, and is determined as the target text.

In the method in this embodiment, it is considered that the text in the image-text pair in the original data set is relatively reliable. When a ranking of the text is greater than a certain ranking in similarity matching ranking, it is considered that the original text is more appropriate, and the original text is preferably selected instead of using a candidate text with a highest similarity generated by the model.

Correspondingly, according to an implementation, before the target text is determined based on the matching result, a size relationship between a target image-text matching degree of any target image-text pair and a predetermined matching degree threshold can be further determined. When the target image-text matching degree is less than or equal to the threshold, that is, when the target image-text pair is not reliable enough, the generated text corresponding to the candidate image with the highest similarity is directly determined as the target text by using the method in the first embodiment. When the target image-text matching degree is greater than the threshold, that is, when the target image-text pair is relatively reliable, the target text is determined based on the ranking position of the seed candidate image in the similarity sorting by using the method in the second embodiment.

Finally, in step 3068, the second image-text pair is formed by using the first image and the target text, and added to the target training set, to continue to train the content understanding model and the content generation model.

After all image-text pairs in the noise-containing sample set are processed by using the method in steps 3062 to 3068, sample processing on the noise-containing sample set is completed.

In some possible implementations, the method further includes:

Step 308: Continue to train the content understanding model and the content generation model by using the updated target training set; or continue to train the content understanding model and the content generation model by using an image-text pair newly added to the target training set.

By using step 308, the content understanding model and the content generation model are trained again by using the cleaned data set, to obtain a content understanding model and a content generation model that are completely trained with full data.

In some possible implementations, before step 304, the method further includes:

Step 302: Obtain the target training set and the noise-containing sample set, and divide the noise-containing sample set into a first subset to an Nth subset, where image-text matching degrees of image-text pairs in the first subset to the Nth subset decrease sequentially.

In this case, the performing sample processing on the noise-containing sample set in step 306 can include: sequentially performing the sample processing on the first subset to the Nth subset.

Step 308 can include: each time one or more rounds of sample processing are performed, continuing to train the content understanding model and the content generation model by using the updated target training set; or continuing to train the content understanding model and the content generation model by using an image-text pair newly added to the target training set.

By using step 302 and step 308, data set cleaning and model training are alternately implemented, to improve a cleaning effect on a noise-containing subset with a relatively low image-text matching degree.

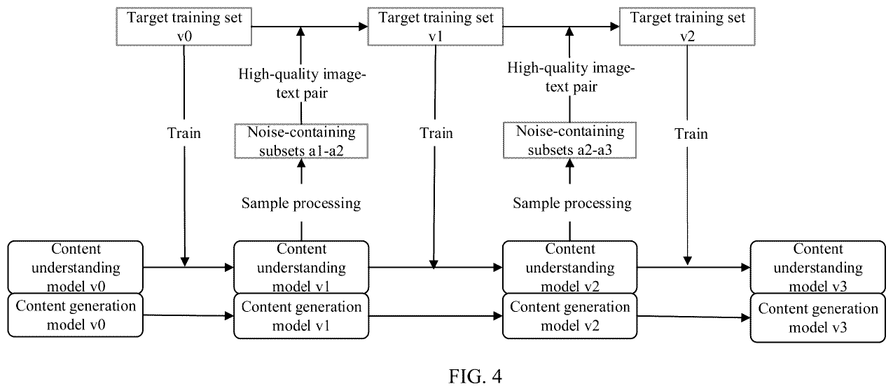

FIG. 4 is a schematic diagram illustrating a scenario in which data set cleaning and model training are performed alternately, according to an embodiment. As shown in FIG. 4, after image-text pairs in an initial data set are sorted in descending order of image-text matching degrees, some image-text pairs with relatively high matching degrees are selected as a target training set, a version of the target training set in this case is recorded as a target training set v0, and a version of an initial content understanding model and a version of an initial content generation model are respectively recorded as a content understanding model v0 and a content generation model v0. The target training set v0 is used to separately train the content understanding model v0 and the content generation model v0 to obtain a trained content understanding model v1 and a trained content generation model v1. Then, the content understanding model v1 and the content generation model v1 are used to perform sample processing on one or more noise-containing subsets al to a2, and a high-quality image-text pair obtained through sample processing is added to the target training set v0, to obtain an updated target training set v1.

Then, the target training set v1 is used to separately train the content understanding model v1 and the content generation model v1, to obtain a trained content understanding model v2 and a trained content generation model v2. Then, sample processing is performed on one or more noise-containing subsets a2 to a3 by using the content understanding model v2 and the content generation model v2, and a high-quality image-text pair obtained through sample processing is added to the target training set v1 to obtain an updated target training set v2.

The previous steps are repeated until all noise-containing subsets are processed to obtain a target training set vn, a content understanding model vn+1, and a content generation model vn+1.

In an embodiment, step 302 can include: obtaining a first training set, where the first training set includes several image-text pairs formed by images and texts, and the text is used to describe content of the image; sorting the several image-text pairs in the first training set in descending order of image-text matching degrees, dividing the first training set into N+1 subsets based on a sorting result, and using an initial subset as the target training set and the remaining N subsets as the first subset to the Nth subset sequentially.

The first training set can be the large-scale low-quality image-text pair training set in FIG. 2. Division of subsets can be performed based on a predetermined sample proportion, or can be performed based on a predetermined matching degree threshold, which is not limited here.

The first training set includes a third image-text pair, the third image-text pair includes a third image and a third text, and an image-text matching degree of the third image-text pair is determined by using the following method: inputting the third image into an image encoder of a multi-modal model to obtain a third image representation, where the multi-modal model further includes a text encoder, and the image encoder and the text encoder are jointly pre-trained, so encoding results of the image encoder and the text encoder are located in a same representation space; inputting the third text into the text encoder to obtain a third text representation; and calculating a similarity between the third image representation and the third text representation, and determining the similarity as the image-text matching degree of the third image-text pair.

The multi-modal model can be a pre-trained CLIP model, or another multi-modal model including a jointly pre-trained text encoder and image encoder. A similarity between representations can be determined by using a point product similarity or a cosine similarity.

In this embodiment of this specification, the content understanding model and the content generation model are jointly trained, and two types of models can be simultaneously trained. In addition, in this solution, a more matched image description is generated for a low-quality image-text pair to obtain a high-quality image-text pair, so in a model iteration process, a large-scale low-quality image-text pair data set is converted into a high-quality image-text pair data set, which helps train another model subsequently. In addition, optionally, only a small quantity of manual labeling needs to be introduced in a cleaning process, to complete cleaning of a large-scale low-quality data set and produce a high-quality large-scale data set.

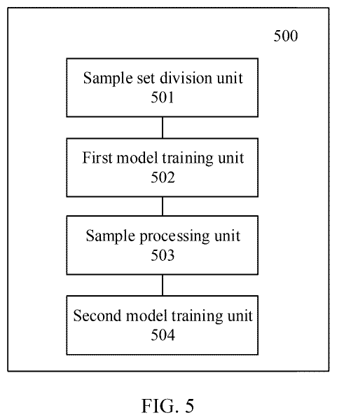

According to another embodiment, an apparatus for training a content understanding model and a content generation model is further provided. FIG. 5 is a schematic block diagram illustrating an apparatus for training a content understanding model and a content generation model, according to an embodiment. The apparatus can be deployed in any device, platform, or device cluster having computing and processing capabilities. As shown in FIG. 5, the apparatus 500 includes: a first model training unit 502, configured to separately train a content understanding model and a content generation model by using an image-text pair formed by an image and a text in a target training set, where the content understanding model is used to generate an image description text based on an input image, and the content generation model is used to generate a corresponding image based on an input description text; and a sample processing unit 503, configured to: perform sample processing on a noise-containing sample set, where an image-text matching degree of an image-text pair in the noise-containing sample set is less than that in the target training set, and the sample processing includes: inputting a first image in any first image-text pair in the noise-containing sample set into the content understanding model to obtain several candidate texts; separately inputting a first text in the first image-text pair and the several candidate texts into the content generation model to obtain multiple candidate images; performing similarity matching between the multiple candidate images and the first image, and determining a target text based on a matching result; and forming a second image-text pair by using the first image and the target text and adding the second image-text pair to the target training set, to continue to train the content understanding model and the content generation model.

In some possible implementations, the apparatus 500 further includes: a second model training unit 504, configured to continue to train the content understanding model and the content generation model by using the updated target training set; or configured to continue to train the content understanding model and the content generation model by using an image-text pair newly added to the target training set.

In some possible implementations, the apparatus 500 further includes: a sample set division unit 501, configured to: obtain the target training set and the noise-containing sample set, and divide the noise-containing sample set into a first subset to an Nth subset, where image-text matching degrees of image-text pairs in the first subset to the Nth subset decrease sequentially; and In this case, the performing sample processing on a noise-containing sample set includes: sequentially performing the sample processing on the first subset to the Nth subset.

Based on an embodiment of another aspect, a computer-readable storage medium that stores a computer program is further provided. When the computer program is executed on a computer, the computer is enabled to perform the method described in any one of the previous embodiments.

Based on an embodiment of still another aspect, a computing device is further provided, including a memory and a processor. The memory stores executable code, and when executing the executable code, the processor implements the method the method described in any one of the previous embodiments.

The embodiments in this specification are described in a progressive way. For the same or similar parts of the embodiments, references can be made to the embodiments. Each embodiment focuses on a difference from other embodiments. Particularly, an apparatus embodiment is similar to a method embodiment, and therefore is described briefly. For a related part, references can be made to some descriptions in the method embodiment.

Specific embodiments of this specification are described above. Other embodiments fall within the scope of the appended claims. In some situations, the actions or steps described in the claims can be performed in an order different from the order in the embodiments and the desired results can still be achieved. In addition, the process depicted in the accompanying drawings does not necessarily need a particular execution order to achieve the desired results. In some implementations, multi-tasking and concurrent processing is feasible or may be advantageous.

It is worthwhile to note that in this specification, relational terms such as “first” and “second” are only used to distinguish one entity or operation from another, and do not necessarily require or imply that any actual relationship or sequence exists between these entities or operations. In addition, the terms “include”, “comprise”, or their any other variant is intended to cover a non-exclusive inclusion, so a process, a method, an article, or an apparatus that includes a list of elements not only includes those elements but also includes other elements that are not expressly listed, or further includes elements inherent to such process, method, article, or apparatus. An element described by “includes a . . . ” further includes, without more constraints, another identical element in the process, method, article, or apparatus that includes the element.

A person of ordinary skill in the art can understand that all or some of the steps of the embodiments can be implemented by hardware, or can be implemented by a program instructing related hardware. The program can be stored in a computer-readable storage medium. The storage medium can be a read-only memory, a magnetic disk, an optical disc, etc.

In the described specific implementations, the objective, technical solutions, and benefits of the present disclosure are further described in detail. It should be understood that the descriptions are merely specific implementations of the present disclosure, but are not intended to limit the protection scope of the present disclosure. Any modification, equivalent replacement, or improvement made without departing from the spirit and principle of the present disclosure should fall within the protection scope of the present disclosure.

What is claimed is:

1. A computer-implemented method for content understanding model and content generation model training, comprising:
separately training a content understanding model and a content generation model with an image-text pair formed by an image and a text in a target training set, wherein the content understanding model is used to generate an image description text based on an input image, and wherein the content generation model is used to generate a corresponding image based on an input description text; and
performing sample processing on a noise-containing sample set, wherein an image-text matching degree of an image-text pair in the noise-containing sample set is less than that in the target training set, and the sample processing comprises:
inputting a first image in any first image-text pair in the noise-containing sample set into the content understanding model to obtain several candidate texts;
separately inputting a first text in the first image-text pair and the several candidate texts into the content generation model to obtain multiple candidate images;
performing similarity matching between the multiple candidate images and the first image, and determining a target text based on a matching result; and
forming a second image-text pair by using the first image and the target text and adding the second image-text pair to the target training set, as an updated target training set, to continue to train the content understanding model and the content generation model.

2. The computer-implemented method of claim 1, comprising:
continuing, using the updated target training set, to train the content understanding model and the content generation model; or
continuing to train the content understanding model and the content generation model by using an image-text pair newly added to the target training set.

3. The computer-implemented method of claim 1, comprising:
obtaining the target training set and the noise-containing sample set, and dividing the noise-containing sample set into a first subset to an Nth subset, wherein image-text matching degrees of image-text pairs in the first subset to the Nth subset decrease sequentially; and
the performing sample processing on a noise-containing sample set comprises:
sequentially performing the sample processing on the first subset to the Nth subset.

4. The computer-implemented method of claim 3, wherein the obtaining the target training set and the noise-containing sample set, and dividing the noise-containing sample set into a first subset to an Nth subset, comprises:
obtaining a first training set, wherein the first training set comprises several image-text pairs formed by images and texts; and
sorting the several image-text pairs in the first training set in descending order of image-text matching degrees, dividing the first training set into N+1 subsets based on a sorting result, and using an initial subset as the target training set and remaining N subsets as the first subset to the Nth subset sequentially.

5. The computer-implemented method of claim 4, wherein:
the first training set comprises a third image-text pair;
the third image-text pair comprises a third image and a third text; and
an image-text matching degree of the third image-text pair is determined by:
inputting the third image into an image encoder of a multi-modal model to obtain a third image representation, wherein the multi-modal model comprises a text encoder, and the image encoder and the text encoder are jointly pre-trained, so encoding results of the image encoder and the text encoder are located in a same representation space;
inputting the third text into the text encoder to obtain a third text representation; and
calculating a similarity between the third image representation and the third text representation, and determining the similarity as the image-text matching degree of the third image-text pair.

6. The computer-implemented method of claim 5, wherein the multi-modal model is a contrastive language-image pre-training (CLIP) model.

7. The computer-implemented method of claim 1, wherein performing similarity matching between the multiple candidate images and the first image, comprises:
separately inputting the multiple candidate images and the first image into an image encoder to obtain multiple candidate image representations and a first image representation; and
separately performing similarity matching between the multiple candidate image representations and the first image representation.

8. The computer-implemented method of claim 7, wherein the image encoder is an image encoder of a contrastive language-image pre-training (CLIP) model.

9. The computer-implemented method of claim 1, wherein determining a target text based on a matching result, comprises:
determining a candidate image having a highest similarity with the first image as a first target image; and
determining, as the target text, a text used when the first target image is generated.

10. The computer-implemented method of claim 1, wherein:
the multiple candidate images comprise a seed candidate image generated based on the first text; and
determining a target text based on a matching result, comprises:
sorting the multiple candidate images in descending order of similarities with the first image, and determining a ranking position of the seed candidate image in the sorting as a first ranking position; and
if the first ranking position is less than or equal to a predetermined first threshold, determining the first text as the target text;
if the first ranking position is greater than or equal to a predetermined second threshold, determining an image having a highest similarity as a second target image, and determining, as the target text, a text used when the second target image is generated; or
if the first ranking position is greater than the predetermined first threshold and is less than the predetermined second threshold, sending the first text, the first image, and the several candidate texts to a manual labeling platform, and determining a text returned by the manual labeling platform as the target text.

11. A non-transitory, computer-readable medium storing one or more instructions executable by a computer system to perform one or more operations, comprising:
separately training a content understanding model and a content generation model with an image-text pair formed by an image and a text in a target training set, wherein the content understanding model is used to generate an image description text based on an input image, and wherein the content generation model is used to generate a corresponding image based on an input description text; and
performing sample processing on a noise-containing sample set, wherein an image-text matching degree of an image-text pair in the noise-containing sample set is less than that in the target training set, and the sample processing comprises:
inputting a first image in any first image-text pair in the noise-containing sample set into the content understanding model to obtain several candidate texts;
separately inputting a first text in the first image-text pair and the several candidate texts into the content generation model to obtain multiple candidate images;
performing similarity matching between the multiple candidate images and the first image, and determining a target text based on a matching result; and
forming a second image-text pair by using the first image and the target text and adding the second image-text pair to the target training set, as an updated target training set, to continue to train the content understanding model and the content generation model.

12. The non-transitory, computer-readable medium of claim 11, comprising:
continuing, using the updated target training set, to train the content understanding model and the content generation model; or
continuing to train the content understanding model and the content generation model by using an image-text pair newly added to the target training set.

13. The non-transitory, computer-readable medium of claim 11, comprising:
obtaining the target training set and the noise-containing sample set, and dividing the noise-containing sample set into a first subset to an Nth subset, wherein image-text matching degrees of image-text pairs in the first subset to the Nth subset decrease sequentially; and
the performing sample processing on a noise-containing sample set comprises:
sequentially performing the sample processing on the first subset to the Nth subset.

14. The non-transitory, computer-readable medium of claim 13, wherein the obtaining the target training set and the noise-containing sample set, and dividing the noise-containing sample set into a first subset to an Nth subset, comprises:
obtaining a first training set, wherein the first training set comprises several image-text pairs formed by images and texts; and
sorting the several image-text pairs in the first training set in descending order of image-text matching degrees, dividing the first training set into N+1 subsets based on a sorting result, and using an initial subset as the target training set and remaining N subsets as the first subset to the Nth subset sequentially.

15. The non-transitory, computer-readable medium of claim 14, wherein:
the first training set comprises a third image-text pair;
the third image-text pair comprises a third image and a third text; and
an image-text matching degree of the third image-text pair is determined by:
inputting the third image into an image encoder of a multi-modal model to obtain a third image representation, wherein the multi-modal model comprises a text encoder, and the image encoder and the text encoder are jointly pre-trained, so encoding results of the image encoder and the text encoder are located in a same representation space;
inputting the third text into the text encoder to obtain a third text representation; and
calculating a similarity between the third image representation and the third text representation, and determining the similarity as the image-text matching degree of the third image-text pair.

16. The non-transitory, computer-readable medium of claim 15, wherein the multi-modal model is a contrastive language-image pre-training (CLIP) model.

17. The non-transitory, computer-readable medium of claim 11, wherein performing similarity matching between the multiple candidate images and the first image, comprises:
separately inputting the multiple candidate images and the first image into an image encoder to obtain multiple candidate image representations and a first image representation; and
separately performing similarity matching between the multiple candidate image representations and the first image representation.

18. The non-transitory, computer-readable medium of claim 17, wherein the image encoder is an image encoder of a contrastive language-image pre-training (CLIP) model.

19. The non-transitory, computer-readable medium of claim 11, wherein determining a target text based on a matching result, comprises:
determining a candidate image having a highest similarity with the first image as a first target image; and
determining, as the target text, a text used when the first target image is generated.

20. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
separately training a content understanding model and a content generation model with an image-text pair formed by an image and a text in a target training set, wherein the content understanding model is used to generate an image description text based on an input image, and wherein the content generation model is used to generate a corresponding image based on an input description text; and
performing sample processing on a noise-containing sample set, wherein an image-text matching degree of an image-text pair in the noise-containing sample set is less than that in the target training set, and the sample processing comprises:
inputting a first image in any first image-text pair in the noise-containing sample set into the content understanding model to obtain several candidate texts;
separately inputting a first text in the first image-text pair and the several candidate texts into the content generation model to obtain multiple candidate images;
performing similarity matching between the multiple candidate images and the first image, and determining a target text based on a matching result; and
forming a second image-text pair by using the first image and the target text and adding the second image-text pair to the target training set, as an updated target training set, to continue to train the content understanding model and the content generation model.
